(19) United States
(12) Patent Application Publication
(10) Pub. No.: US 2025/0219532 A1
(43) Pub. Date: Jul. 3, 2025

(54) MULTI CHARGER CAPABLE OF SIMULTANEOUS CHARGING OF THE SAME TYPE AND DIFFERENT TYPES

(71) Applicant: UNICO GRID Co., Ltd., Gyeongsangnam-do (KR)

(72) Inventor: Yoon Sang KOOK, Gyeonggi-do (KR)

(73) Assignee: UNICO GRID Co., Ltd., Gyeongsangnam-do (KR)

(21) Appl. No.: 18/986,596

(22) Filed: Dec. 18, 2024

(30) Foreign Application Priority Data
Dec. 29, 2023 (KR) 10-2023-0197791

(51) Int. Cl. H02M 3/00; H02J 7/00

(52) U.S. Cl. CPC H02M 3/003; H02J 7/0042; H02M 3/01; H02J 2207/20

(57) ABSTRACT

The present invention provides a multi charger capable of simultaneous charging of the same type and different types, which comprises a control circuit unit designed to charge batteries of different voltage levels and a mounting unit for parallel connection.

### CROSS-REFERENCE TO RELATED APPLICATION

The present application claims priority under 35 U.S.C § 119(a) to Korea Patent Application No. 10-2023-0197791 filed on Dec. 29, 2023, which is hereby expressly incorporated by reference, in its entirety, into the present application.

### BACKGROUND

### 1. Technical Field

The present invention relates to a multi-charger capable of simultaneously charging various types of batteries of industrial mobile equipment, the multi-charger being capable of automatically recognizing and charging batteries having different voltage levels in a 1:1 (charger:battery) ratio, and operating a plurality of chargers in parallel through a communication interface in an n:1 (charger:battery) ratio, so as to increase capacity, thereby enabling capacity to be increased using a single standard model rather than providing separate chargers for each capacity.

### 2. Related Art

In UU Green Power Electric Co., Ltd.'s application WO2020232924A1, a DC/DC converter was configured using an LLC resonant converter.

LLC resonant converters have higher efficiency than other topologies, but have the disadvantage of being difficult to control the output voltage widely.

To solve the above problem, relays K1 and K2/K2 were used on the secondary output terminal to control the output voltage widely.

In addition, existing charging systems have the inconvenience of having to individually charge batteries of different voltage levels.

This means that separate chargers are required for each battery type, which is space and cost inefficient.

The present invention aims at a system capable of efficiently charging batteries of various voltage levels using one standard model.

This improves user convenience and efficiency in terms of space and cost.

The charging system of the present invention using an LLC resonant DC/DC converter can automatically recognize and charge batteries of various voltage levels.

It also provides the ability to connect multiple chargers in parallel to increase charging capacity.

This provides the flexibility to charge multiple batteries simultaneously with one charger.

### Prior Art Documents

### Patent Documents

(Patent Documents 0001) KR 10-2696957 B1
(Patent Documents 0002) WO 2020232924 A1

### SUMMARY

The present invention has been made to solve the above problems, and an object of the present invention is to provide a multi charger capable of simultaneous charging of the same type and different types capable of automatically recognizing batteries of various voltage levels and efficiently charging them.

Another object of the present invention is to provide a multi charger capable of simultaneous charging of the same type and different types, which can provide the ability to charge multiple batteries simultaneously using one standard model.

Another object of the present invention is to provide a multi charger capable of simultaneous charging of the same type and different types for increasing the total charging capacity by connecting multiple chargers in parallel.

The tasks of the present invention are not limited to the tasks mentioned above, and other tasks not mentioned will be clearly understood by those skilled in the art from the description below.

A multi charger capable of simultaneous charging of the same type and different types according to an embodiment of the present invention for solving the above problem may include a control circuit unit equipped to control an output voltage using an LLC resonant DC/DC converter so as to charge batteries of different voltage levels.

In one embodiment, the control circuit unit may include a burst mode PID controller configured to maintain a constant voltage under no-load conditions by applying PWM (Pulse Width Modulation) by creating a pulse of a maximum switching (F max) frequency, a duty mode PID controller configured to fix the frequency under light-load conditions and change the duty within a preset range, and to symmetrically maintain the upper and lower parts balanced by using a method of outputting a Center-aligned complementary PWM waveform for the switching waveforms of the upper and lower parts of the PWM, and a frequency mode PID controller configured to control the output by adjusting the frequency of the PWM signal from F max to F min while having a preset range of duty.

In one embodiment, a multi charger capable of simultaneous charging of the same type and different types may further include a mounting unit secured and secured for parallel connection of multiple chargers.

In one embodiment, the mounting unit includes a mounting case having a mounting space for mounting a charger, mounting guide unit installed on both sides of the mounting case to guide mounting of a charger accommodated in the mounting space, and the mounting guide unit includes a guide portion support plate installed to support both sides of the charger, a connection fixing plate installed integrally with the shape of the guide unit support plate on an outer surface of the guide unit support plate, a guide unit plate installed integrally with the shape of the guide unit support plate on an outer surface of the connection fixing plate, a plate support member installed on a lower of the guide unit support plate to support the guide unit support plate, a support rotation roller rotatably connected to a lower of the plate support member to adjust an angle of the plate support member, a guide unit shaft that is vertically inserted toward a case wing of the mounting case while the support rotation roller is disposed at an upper and is provided to enable vertical movement, an elastic member installed on a lower of the guide unit shaft and capable of moving up and down along a guide groove of the case wing while alleviating shock, and a support member that is supported when the elastic member moves up and down along the guide groove. The case wing may include a support plate built into the case wing, a detachable frame formed to extend horizontally from the elastic member to protrude outward from the case wing and configured to raise and lower the elastic member, a mounting guide member rotatably connected to the lower end of the guide member plate and configured to be supported by the guide member shaft, and a mounting protrusion unit provided at the end of the mounting guide member to support the load of the charger.

In one embodiment, the mounting protrusion unit includes a curved mounting protrusion provided to support and mount the lower part of the charger, a roller support wing formed to extend rearwardly from the curved mounting protrusion, a protrusion body provided to mount the rear of the curved mounting protrusion but be supported by the roller support wing and arranged at the end of the mounting guide member, a roller support frame vertically built into the interior of the protrusion body, a roller detachment prevention frame integrally formed vertically on the front side of the protrusion body, a protrusion lifting roller supported by the roller support frame but rotatably provided while being connected to the roller support wing to raise and lower the curved mounting protrusion, a rear support member provided to be installed vertically at the rear end of the protrusion body and to support the protrusion body at the end of the mounting guide member, and a member buffer cylinder member installed toward the end of the mounting guide member from the rear support member and rotatably provided to the rear support member, wherein the member buffer cylinder member includes a buffer rod shaft having one end rotatably connected to the rear support member. The buffer rod shaft may include a buffer cylinder rotatably connected to a distal end of the mounting guide member, into which the buffer rod shaft is inserted so as to enable piston movement toward the inside, and a protrusion spring inserted into a circumferential portion of the buffer rod shaft to generate elastic force and elastically support the piston movement of the buffer rod shaft.

According to the present invention, a multi charger capable of simultaneous charging of the same type and different types is provided, which comprises a control circuit unit designed to charge batteries of different voltage levels and a mounting unit for parallel connection.

Increased efficiency: Charge batteries of different voltage levels with a single charger, eliminating the need to purchase or maintain separate chargers.

Provides flexibility: Multiple chargers can be connected in parallel to increase capacity, meeting large-scale charging needs.

Automatic recognition and charging: Automatically recognizes and effectively charges batteries of different voltage levels using LLC resonant DC/DC converter.

The effects according to the present invention are not limited to those exemplified above, and more diverse effects are included in the present invention.

### BRIEF DESCRIPTION OF THE DRAWINGS

FIGS. 1-8 illustrate circuit diagram embodiments according to the present invention.

FIGS. 9-10 illustrate detailed configurations of a mounting guide unit according to the present invention.

FIG. 11 illustrates detailed configurations of a mounting projection according to the present invention.

### DESCRIPTION OF EXEMPLARY EMBODIMENTS

Hereinafter, various embodiments will be described in more detail with reference to the attached drawings. The embodiments described in this specification can be modified in various ways. Specific embodiments may be depicted in the drawings and described in detail in the detailed description. However, specific embodiments disclosed in the attached drawings are only intended to facilitate easy understanding of various embodiments. Therefore, the technical idea is not limited by the specific embodiments disclosed in the attached drawings, but should be understood to include all equivalents or substitutes included in the spirit and technical scope of the invention.

Terms that include ordinal numbers, such as first, second, etc., may be used to describe various components, but these components are not limited by the above-described terms. The above-described terms are used only for the purpose of distinguishing one component from another.

In this specification, it should be understood that terms such as “include” or “have” are intended to specify the presence of a feature, number, step, operation, component, part or combination thereof described in the specification, but do not exclude in advance the possibility of the presence or addition of one or more other features, numbers, steps, operations, components, parts or combinations thereof. When it is stated that a certain component is “connected” or “connected” to another component, it should be understood that it may be directly connected or connected to the other component, but that other components may also be present in between. On the other hand, when it is stated that a certain component is “directly connected” or “directly connected” to another component, it should be understood that no other components exist in between.

Meanwhile, the “module” or “unit” for the component used in this specification performs at least one function or operation. And the “module” or “unit” can perform the function or operation by hardware, software, or a combination of hardware and software. In addition, a plurality of “modules” or a plurality of “units” excluding a “module” or “unit” that must be performed in a specific hardware or performed in at least one processor may be integrated into at least one module. The singular expression includes the plural expression unless the context clearly indicates otherwise.

In addition, the power and power transmission and control thereof for the following assembly configurations and embodiments including “by control” follow the conventional technology and are therefore omitted to avoid redundant description.

In addition, the operation examples and configurations described schematically without detailed explanation below follow the conventional technology and are omitted in order to focus on describing the purpose of the present invention and the resulting effects.

In addition, when describing the present invention, if it is determined that a specific description of a related known function or configuration may unnecessarily obscure the gist of the present invention, the detailed description thereof is abbreviated or omitted.

A brief explanation of the terms in the drawing is as follows.

PWM (Pulse Width Modulation) is a technology used to control voltage and current, and can compensate for efficient power transfer under various load conditions.

Subcrimposed Frequency Droop Link can maintain circuit stability by adjusting the frequency according to load changes.

Reactive Circulating Power-Voltage Regulation Link can improve the responsiveness of a circuit by regulating the voltage.

Virtual Negative Impedance is a feature that allows you to optimize power flow by controlling impedance.

Soft Start Link can supply power without putting a strain on the circuit. Therefore, it can protect the charger and circuit by gradually increasing the power in the initial stage of charging.

Voltage and Current Double-Loop Control Link enables precise power management by controlling voltage and current simultaneously.

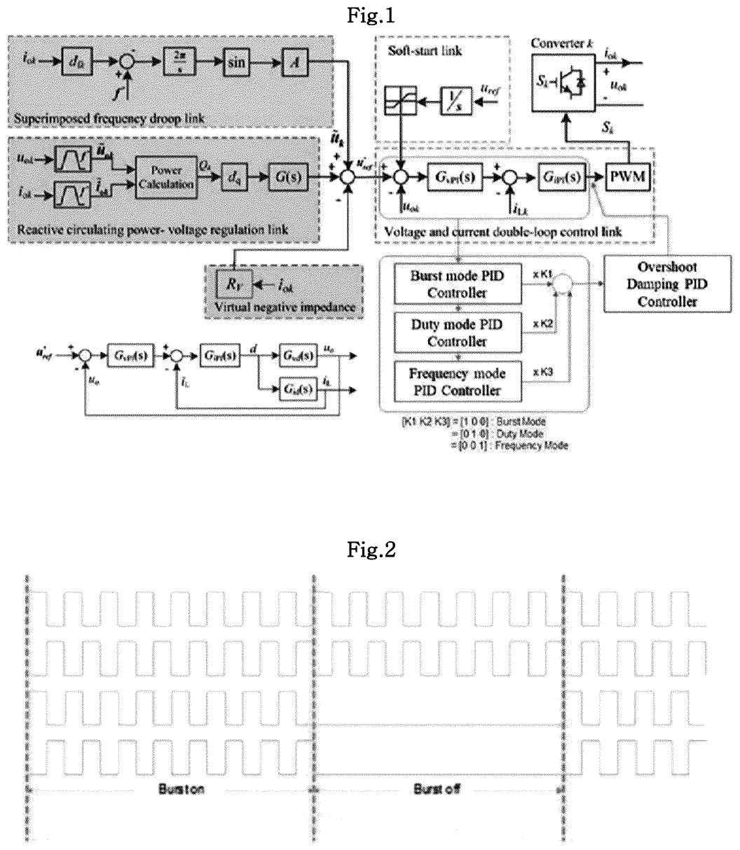

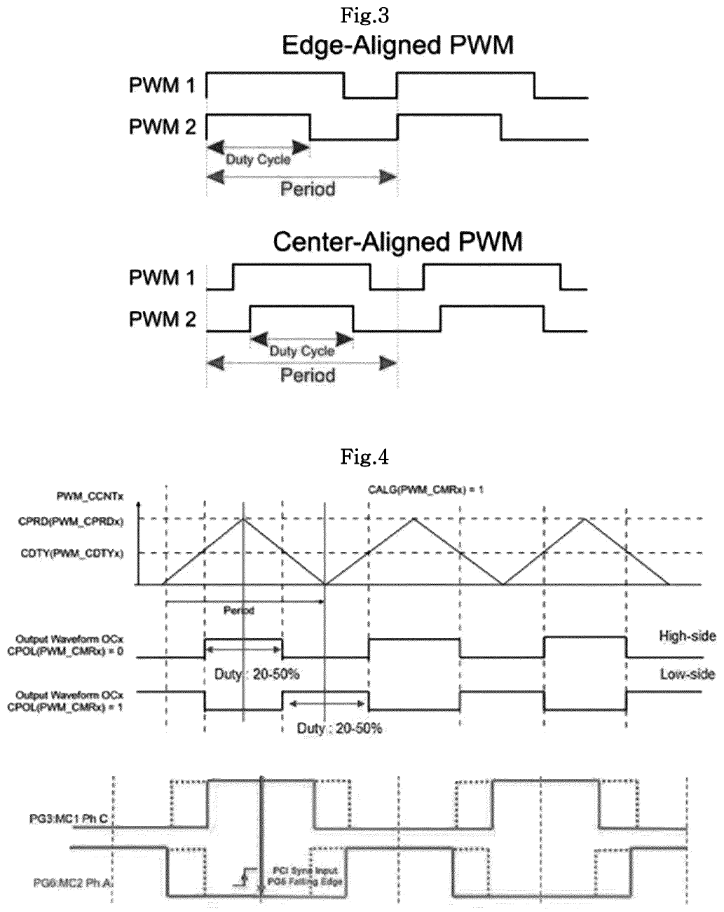

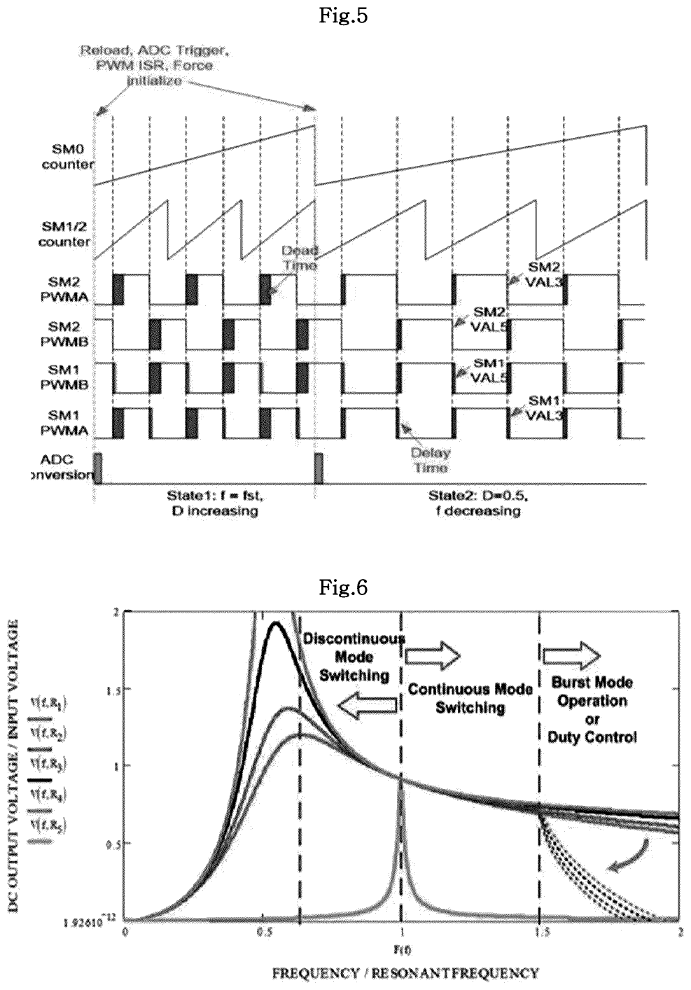

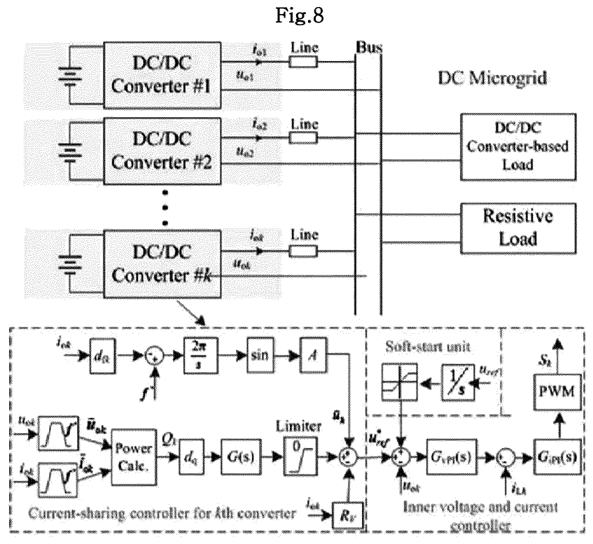

FIGS. 1-8 illustrate circuit diagram embodiments according to the present invention.

Referring to FIGS. 1-8, a multi charger capable of simultaneous charging of the same type and different types may include a control circuit unit 10 equipped to charge batteries of different voltage levels of various devices by controlling an output voltage using an LLC resonant DC/DC converter.

At this time, PWM is used as a core to control the output voltage and current, and together with the LLC resonant DC/DC converter, the charging parameters can be adjusted to suit various voltage levels.

The control circuit unit 10 may include a Burst Mode PID controller, a Duty Mode PID controller, a Frequency Mode PID controller, and an Overshoot Damping PID controller.

A Burst Mode PID controller 11 can be provided to maintain a constant voltage under no-load conditions by creating a pulse of maximum switching (F max) frequency and applying PWM (Pulse Width Modulation).

The Duty Mode PID controller 12 can be equipped to maintain symmetrical balancing of the upper and lower parts by using a method of outputting a Center-aligned complementary PWM waveform in which the switching waveform of the upper and lower parts of the PWM is fixed and the duty is varied within a preset range (20% to 50%) under light load conditions.

Generally, there are two edge methods for generating PWM: Edge-aligned PWM and Center-aligned PWM.

The Frequency Mode PID controller 13 can be equipped to control the output by adjusting the frequency of the PWM signal from F max to F min while having a duty of a preset range (50%).

Since the LLC resonant DC/DC converter has a basic voltage gain characteristic and the gain change is not large even if it is controlled to switch above F max, it is necessary to lower the voltage gain through burst mode or duty mode when it exceeds the set F max.

In one embodiment, frequency adjustment of all PID controllers and Subcrimposed Frequency Droop Link can be associated to ensure stable operation under various load conditions.

In one embodiment, Virtual Negative Impedance can be used as part of the feedback control of any PID controller to optimize power flow and improve efficiency.

In one embodiment, a Voltage and Current Double-Loop Control Link associated with precise control of output parameters can be linked with any PID controller for adaptive and efficient charging regardless of load conditions.

In one embodiment, the control circuit unit 10 can sense the current at the upper end (+terminal of the output) when operating multiple chargers in parallel and perform balancing control so that the same current is distributed to all power modules.

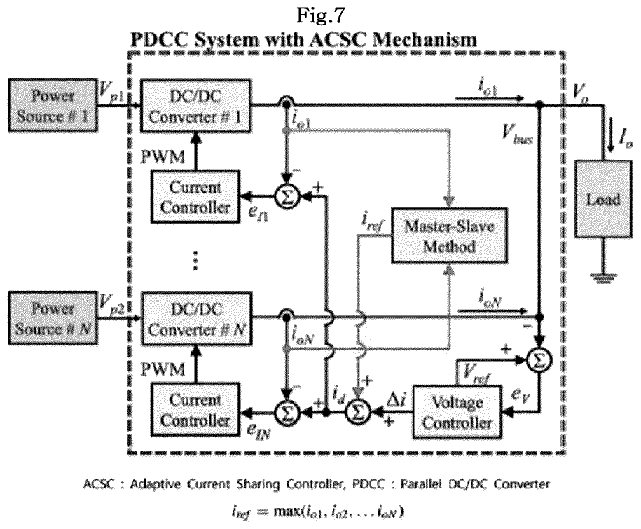

In one embodiment, referring to FIG. 7, N is the number of parallel-connected converters, and iok is the output current of the kth converter. The modified current id is obtained by adding the reference current iref and the compensation signal i. Consequently, the current control error elk can be determined by comparing the actual output current iok with the current command id as elk=id−iok. Finally, the PWM control signal can be determined using the current controller with respect to the current error elk. Accordingly, all converters can output equivalent current at the same DC bus voltage to provide higher power required by the load.

In one embodiment, when a plurality of chargers are operated in parallel, they communicate with each other to generate a unique CPU ID so that even if the module IDs overlap, it is possible to know how many are connected, and through this, communication control can be performed to evenly distribute the current so that the current is not concentrated on one side.

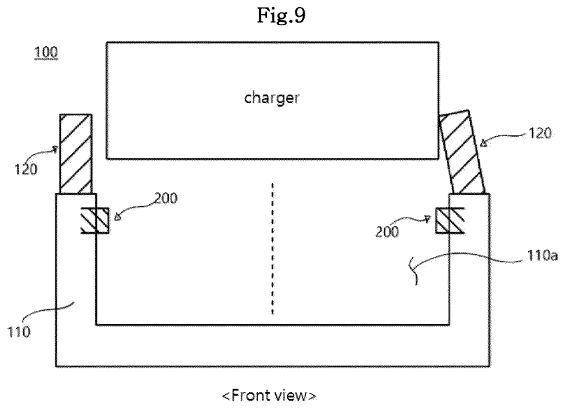

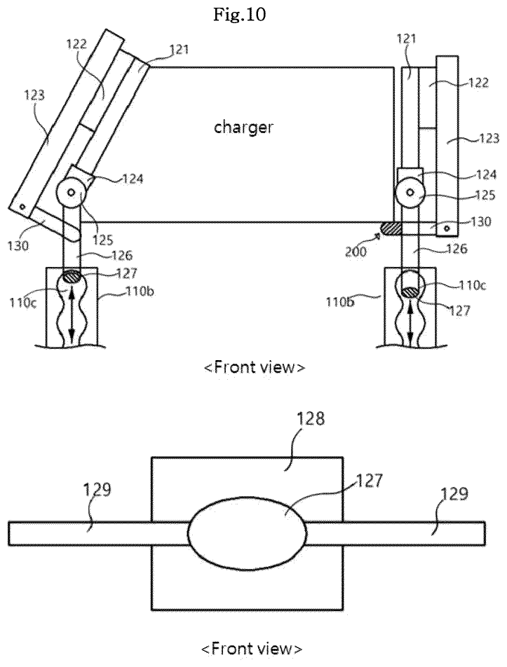

FIGS. 9-10 illustrate detailed configurations of a mounting guide unit according to the present invention.

Referring to FIGS. 9-10, a multi charger capable of simultaneous charging of the same type and different types may include a mounting unit 100 that is connected to support and secure a plurality of chargers for parallel connection.

At this time, the mounting unit 100 can be combined with each of a plurality of chargers to form a single configuration.

The mounting unit 100 may include the mounting case 110, and the mounting guide unit 120.

The mounting case 110 may be provided so that a mounting space 110a in which a charger can be placed is formed.

A mounting guide unit 120 may be installed on both sides of the mounting case 110 to guide mounting of a charger accommodated in the mounting space(110a).

In addition, the mounting guide unit 120 may include a guide unit support plate 121, a connecting fixing plate 122, a guide unit plate 123, a plate support member 124, a support rotation roller 125, a guide unit shaft 126, an elastic member 127, a member support plate 128, a detachable frame 129, a mounting guide member 130, and a mounting protrusion unit 200.

The guide unit support plate 121 can be provided to support both sides of the charger.

The connecting fixing plate 122 may be installed on the outer surface of the guide unit support plate 121 so as to be integral with the shape of the guide unit support plate 121.

The guide unit plate 123 may be installed integrally with the shape of the guide unit support plate 121 on the outer surface of the connecting fixing plate 122.

A plate support member 124 may be installed at the lower of the guide unit support plate 121 to support the guide unit support plate 121.

A support rotation roller 125 may be rotatably attached to the lower of the plate support member 124 to adjust the angle of the plate support member 124.

The guide unit shaft 126 may be inserted vertically toward the case wing 110b of the mounting case 110 while the support rotation roller 125 is positioned at the top, and may be provided so as to be capable of vertical movement.

The elastic member 127 may be installed at the lower end of the guide unit shaft 126 and may be provided to raise and lower along the guide groove 110c of the case wing 110b while alleviating shock.

member support plate 128 may be provided built into the case wing 110b so that the elastic member 127 is supported when raised and lowered along the guide groove 110c.

The detachable frame 129 may be formed to extend horizontally from the elastic member 127 to protrude outwardly from the case wing 110b and may be provided to raise and lower the elastic member 127.

The mounting guide member 130 may be rotatably fastened to the lower end of the guide unit plate 123 and supported by the guide unit shaft 126.

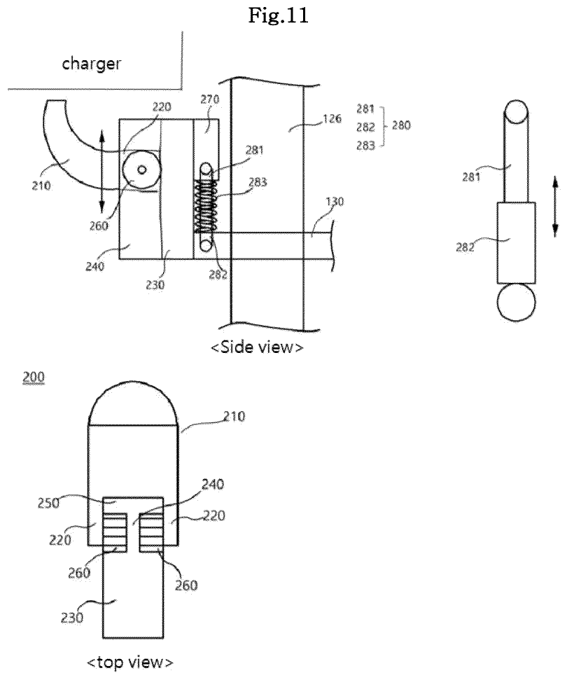

FIG. 11 illustrates detailed configurations of a mounting protrusion unit according to the present invention.

Referring to FIG. 11, a mounting protrusion unit 200 may be installed at the end of the mounting guide member 130 to support the load of the charger.

In addition, the mounting protrusion unit 200 may include a curved mounting protrusion 210, a roller support wing 220, a protrusion body 230, a roller support frame 240, a roller deviation prevention frame 250, a protrusion lifting roller 260, a rear support member 270, and a member buffer cylinder unit 280.

A curved mounting protrusion 210 may be provided to support and mount the lower of the charger.

The roller support wing 220 may be formed to extend to the rear of the above-mentioned curved mounting protrusion 210.

The protrusion body 230 may be provided to be positioned at the end of the mounting guide member 130 while being supported by the roller support wing 220 while mounting the rear of the curved mounting protrusion 210.

The roller support frame 240 may be provided so as to be vertically embedded within the protrusion body 230.

The roller deviation prevention frame 250 may be provided so as to be integrally formed in a vertical direction on the front side of the protrusion body 230.

The protrusion lifting roller 260 may be supported on the roller support frame 240 and may be provided to rotate while being connected to the roller support wing 220 to raise and lower the curved mounting protrusion 210.

The rear support member 270 may be installed vertically at the rear end of the protrusion body 230 and provided to support the protrusion body 230 at the end of the mounting guide member 130.

The member buffer cylinder unit 280 is installed toward the end of the mounting guide member 130 from the rear support member 270, but may be provided so that the rear support member 270 can be rotated.

In addition, the member buffer cylinder unit 280 may include a buffer load shaft 281, a buffer cylinder 282, and a protrusion spring 283.

The buffer load shaft 281 may be provided so that one end thereof is rotatably connected to the rear support member 270.

The buffer cylinder 282 may be provided so that the buffer load shaft 281 is inserted inwardly so as to enable piston movement, and is rotatably connected to the end of the mounting guide member 130.

A protrusion spring 283 may be inserted into the circumference of the buffer load shaft 281 to generate elastic force and elastically support the piston movement of the buffer load shaft 281.

The assembly relationship and the effect of the embodiment according to the above configurations are described in detail based on the drawings as follows.

In a mounting unit 100 that can be used to hold and protect a charger, the charger can be placed in a mounting space 110a of a mounting case 110.

At this time, a mounting guide unit 120 is installed on each case wing 110b of the mounting case 110 to guide the charger to be installed in the mounting space 110a and to protect the mounted charger.

An elastic member 127 is attached to each case wing 110b so as to be vertically movable along a guide groove 110c having a vertically protruding shape.

The elastic member 127 is fixed to one side of the member support plate 128 to support the inside of the case wing 110b, and the member support plate 128 can move integrally with the elastic member 127 moving along the guide groove(110c).

A detachable frame 129 is formed to extend outwardly from both sides of the elastic member 127, and the detachable frame 129 is placed in a frame groove formed in a vertical direction in the guide groove 110c so that the user can control the detachable frame 129 to move the elastic member 127 in the vertical direction.

The guide unit shaft 126 is formed to extend vertically to the elastic member 127.

The support rotation roller 125 is rotatably connected to the upper end of the guide shaft 126.

A plate support member 124 is fixed to the periphery of a support rotation roller 125, and a guide unit support plate 121 is formed to extend in a vertical direction to the plate support member 124.

The inner surface of the guide unit support plate 121 can be in contact with both sides of the charger, and the outer surface is fixed to one side of the connecting fixing plate 122.

At this time, the connecting fixing plate 122 is arranged in the same shape as the guide unit support plate 121.

One side of the guide unit plate 123 is fixed to the other side of the connecting fixing plate 122, and is arranged in the same shape as the connecting fixing plate 122, but the guide unit plate 123 extends downward more than the connecting fixing plate 122.

One end of a mounting guide member 130 is rotatably fastened to the lower end of the guide unit plate 123, and the mounting guide member 130 is mounted through the guide unit shaft 126 as shown in the drawing.

A mounting protrusion 200 is installed on the other end of the mounting guide member 130.

In the mounting protrusion unit 200, it can be installed on the inner surface of each case wing 110b to guide the charger to be installed in the mounting space 110a.

The rear end of the protrusion body 230 is mounted on the other end of the mounting guide member 130.

A rear support member 270 is vertically fixed to the upper part of the rear end of the protrusion body 230.

A curved mounting protrusion 210 are attached to both sides of the protrusion body 230 and arranged to be movable in the vertical direction.

At this time, roller support wings 220 are formed to extend to the rear of the curved mounting protrusion 210 and are mounted on both sides of the protrusion body 230 to support the curved mounting protrusion 210.

Inside the protrusion body 230, a protrusion lifting roller 260 is rotatably built in at regular intervals, and a roller support wing 220 and a protrusion lifting roller 260 are arranged in parallel so that a shaft is inserted through the roller support wing 220 and the protrusion lifting roller 260 so that the protrusion lifting roller 260 is supported on the shaft and can rotate.

In particular, the parallel-arranged protrusion lifting rollers 260 can rotate while being supported by a roller support frame 240 formed in a vertical direction.

Likewise, the shaft supporting the protrusion lifting roller 260 can also support the protrusion lifting roller 260 by penetrating and inserting the roller support frame 240.

Next, the front part of the protrusion body 230 is formed integrally with a roller deviation prevention frame 250 in a vertical direction to support the protrusion lifting roller 260 so that it does not deviate when being raised or lowered.

Meanwhile, in the member buffer cylinder unit 280, the rear support member 270 is rotatably fastened toward the other end of the mounting guide member 130.

The upper part of the buffer load shaft 281 is rotatably connected to the rear support member 270, and a buffer cylinder 282 is inserted into the periphery of the buffer load shaft 281, so that the lower part of the buffer cylinder 282 is rotatably connected.

A protrusion spring 283 is inserted into the circumference of the buffer load shaft 281 to generate elastic force according to the piston movement of the buffer load shaft 281 and elastically support the rear support member 270.

### Embodiment

Step 0: The user supports both sides of each charger on the guide unit support plate 121, thereby rotating the guide unit support plate 121 by the support rotation roller 125 to adjust the angle in the vertical direction.

Step 1: The user places the charger on the mounting protrusion unit 200.

Step 2: The elastic member 127 and the guide unit shaft 126 elastically descend along the guide groove 110c due to the load of the charger.

Step 3: The lower two sides of the charger are mounted on the curved mounting protrusion 210 for Step 1.

Step 4: The protrusion lifting roller 260 is lowered from the protrusion body 230 by the load of the charger.

Step 5: The buffer load shaft 281 of the member buffer cylinder unit 280 can rotate and lower the rear support member 270 while supporting the load of the charger by piston movement in the buffer cylinder 282.

Step 6: The load of the charger is supported by the elastic force of the protrusion spring 283.

Step 7: To detach the charger, the user can raise the charger by lifting the detachable frame 129 from the elastic member 127 out of the guide groove 110c.

Although the preferred embodiments of the present invention have been illustrated and described above, the present invention is not limited to the specific embodiments described above, and various modifications may be made by those skilled in the art without departing from the gist of the present invention as claimed in the claims. Furthermore, such modifications should not be individually understood from the technical idea or prospect of the present invention.

1. A control circuit unit equipped with an LLC resonant DC/DC converter to control the output voltage so as to charge batteries of different voltage levels;
A mounting unit fastened to support and secure the parallel connection of multiple chargers;
Including, In a multi charger capable of simultaneous charging of the same type and different types,
The control circuit unit,
A Burst Mode PID controller provided to maintain a constant voltage under no-load conditions by applying PWM (Pulse Width Modulation) by creating pulses of maximum switching (Fmax) frequency;
A Duty Mode PID controller that maintains symmetrical balancing of the upper and lower parts by using a method of outputting a Center-aligned complementary PWM waveform for the switching waveforms of the upper and lower parts of the PWM while fixing the frequency under light load conditions and changing the duty within a preset range;
A Frequency Mode PID controller provided to control the output by adjusting the frequency of a PWM signal from F max to F min while having a preset range of duty;
Including,
The mounting unit is,
A mounting case with a mounting space where the charger can be placed;
A mounting guide unit installed on both sides of the above mounting case to guide mounting of a charger accommodated in the mounting space;
Including,
The mounting guide unit is,
A guide unit support plate provided to support both sides of the charger;
A connecting fixing plate installed integrally with the shape of the guide unit support plate on the outer surface of the guide unit support plate;
A guide unit plate installed integrally with the shape of the guide unit support plate on the outer surface of the above connecting fixing plate;
A plate support member installed at the lower of the above guide unit support plate and provided to support the above guide unit support plate;
A support rotation roller rotatably connected to the lower of the above plate support member and provided to adjust the angle of the above plate support member;
A guide unit shaft which is inserted vertically toward the case wing of the above-mentioned mounting case while the above-mentioned support rotation roller is positioned at the top, but is equipped to enable vertical movement;
An elastic member installed at the lower end of the above guide unit shaft and capable of moving up and down along the guide groove of the case wing while being provided to cushion shock;
A member support plate built into the case wing to support the elastic member when it is raised and lowered along the guide groove;
A detachable frame formed to extend horizontally from the elastic member to protrude outwardly from the case wing and configured to raise and lower the elastic member;
A mounting guide member rotatably connected to the lower end of the above guide unit plate and provided to be supported by the above guide unit shaft;
A mounting protrusion unit installed at the end of the above mounting guide member to support the load of the charger;
Including,
A multi charger capable of simultaneous charging of the same type and different types.
